(19) United States
(12) Patent Application Publication
(10) Pub. No.: US 2003/0121050 A1
(43) Pub. Date: Jun. 26, 2003

(54) System and method for scheduling interactive audiovisual presentations

(76) Inventors: Hari Kalva, New York, NY (US); Alexandros Eleftheriadis, New York, NY (US)

Correspondence Address: BAKER & BOTTS, 30 ROCKEFELLER PLAZA, NEW YORK, NY, 10112

(21) Appl. No.: 10/149,711

(22) PCT Filed: Dec. 13, 2000
(86) PCT No.: PCT/US00/42797

(51) Int. Cl. H04N 7/173; G06F 9/00

(52) U.S. Cl. 725/97; 709/102

(57) ABSTRACT

A system and method are provided for scheduling an object-based presentation. The system and method can be computer-based and can be embodied as an application program or a hardware module connected to or incorporated into a server. The system and method can perform the following operations: (1) scheduling an object-based presentation over a given connection and (2) scheduling core and interactive portions of an object-based presentation over a given connection.

### BACKGROUND OF THE INVENTION

I. Field of the invention

The present invention relates generally to a method and system for scheduling presentations for transmission over a network or communications link, and more particularly relates to the scheduling of object-based audiovisual presentations.

II. Description of the related art

Traditionally, audiovisual presentations have been composed at the server and transmitted to the client. In one particular technique for displaying audiovisual presentations, known as MPEG-2, there are several shortfalls, not the least of which is that interaction by the end user is not permitted.

However, the advent of new coding and representation techniques, such as the techniques standardized as MPEG-4, have begun to transform image and video encoding. In particular, MPEG-4 has made possible the encoding and representation of audiovisual scenes with objects and the specification of tools that enable object-based audiovisual presentations. These tools include those which encode individual objects, compose presentations with objects, store object-based presentations, and access presentations in a distributed manner over networks.

The main distinguishing feature of object-based audiovisual presentations is the scene composition at the user terminal. Objects are composed and displayed at the user end as opposed to composed at the server end and displayed at the user end as is the case with MPEG-2. Such object-based representation and presentation has several benefits including compression efficiency and the capability to interact with individual objects.

The MPEG-4 systems specification, which is fully described in the MPEG-4 Systems specification is ISO/IEC document ISO/IEC JTC1/SC29/WG11 N2201, the contents of which are incorporated by reference herein, defines an architecture and tools to create audiovisual scenes from individual objects. The scene description and synchronization tools are at the core of the systems specification. The MPEG-4 scene description, also referred to as Binary Format for Scenes, is based on the Virtual Reality Modeling Language and specifies the spatio-temporal composition of objects in a scene. MPEG-4 also specifies the Delivery Multimedia Integration Framework (hereinafter DMIF), a general application and transport delivery framework.

In order to keep the user unaware of underlying transport details, MPEG-4 defined an interface between user level applications and the underlying transport protocol called the DMIF Application Interface (hereinafter DAI). The DAI provides the required functionality for realizing multimedia applications with quality-of-service support. This architecture allows creation of complex presentations with wide-ranging applications. As the complexity of the content increases, so does the complexity of the servers and user-terminals involved. The servers now have to manage multiple objects to deliver a single presentation.

The flexibility of MPEG-4 enables complex interactive presentations but makes the content creation process non-trivial. Unlike MPEG-2, the content creation process involves much more than multiplexing the media streams. Determining the schedulability of a presentation has become important during the content creation process. As designers add objects to make the presentation more engaging, the presentation may become non-schedulable under many circumstances. A presentation designer may add an object that enables animation during the presentation. This additional object may be unimportant to the overall presentation, but may still make the presentation non-schedulable in its new form given a set of resources.

The complexity of an MPEG-4 presentation is an important factor that influences a server's performance. In case of MPEG-2 content, the average bit-rate and peak bit rate are a good indication of the server resources required to deliver the stream. However, an MPEG-4 presentation cannot be characterized by individual or cumulative bit rates of the objects alone. For example, an MPEG-4 presentation may consist of a sequence of large JPEG images with accompanying audio. Such presentations tend to require large amounts of bandwidth for short periods of time over the network. Since objects may span any arbitrary time period during a presentation, the bit-rate of MPEG-4 presentations can be highly variable depending on the content of presentations. When user interaction is allowed, the resulting asynchronous events affect object delivery and add to the variability of the bandwidth needed to deliver the content. Given a set of constraints the user interaction may make the presentation non-schedulable. Accordingly, an improved method of scheduling object-based audiovisual presentations is needed.

### SUMMARY OF THE INVENTION

An object of the present invention is to provide an effective and efficient scheduling system and method where an object-based audiovisual presentation is scheduled such that it is delivered to a destination over a given channel.

Additionally, the present invention seeks to provide authors of object-based audiovisual presentations real time feed back relating to the schedulability of the presentation.

In order to achieve these objectives as well as others that will become apparent with reference to the following specification, the present invention provides systems and methods for scheduling object based audivisual presenttions. In one arrangement, a method for scheduling an object-based audiovisual presentation is provided. The presentation is made of a plurality of objects, wherein each object includes a plurality of access units, and each access unit includes a decode time and data. The method schedules a send time for each access unit over a channel at a capacity. The access units are scheduled in order from the access unit with the greatest decode time to the access unit with the smallest decode time. Advantagously, each access unit is scheduled as closely as possible to the decode time of each access unit. A plurality of gaps may be recorded on the channel while scheduling the presentation. The plurality of gaps can be recorded as a tuple having a start time and a duration.

In an especially preferred arrangement, the method includes the further step of scheduling a second plurality of access units, and scheduling a send time for each access unit over the channel at the capacity. The access units are scheduled in order from the access unit with the greatest decode time to the access unit with the smallest decode time. The access units are scheduled such that each access unit is sent in one of the plurality of gaps. The access units can be sent in gaps of equal or greater duration than the access units. Importantly, access units can be divided into a first portion equal in duration to one of the plurality of gaps and a second portion. With such division, the first portion is sent in the gap, and the second portion is send in at least one of the plurality of gaps. Each access unit is scheduled in the first gap preceding the decode time of each access unit.

The method provided by the present invention is especially advantegeous when each object includes a priority, so that a second object will not be scheduled if both the first object and the second object cannot be scheduled and the first object's priority is higher than the second object's priority. Moreover, the capacity which can be set at a first capacity may be increased to a second capacity and a schedule computed if no schedule could be found at the first capacity. Further, each access unit should must be scheduled before a maximum setup time.

In accordance with another preferred arrangement, a system for scheduling an object-based audiovisual presentation is provided. The presentation includes a plurality of objects, wherein each object includes a plurality of access units, and wherein each access unit includes a decode time and data. The system also includes an object scheduler for scheduling a send time for each access unit over a channel at a capacity. The object scheduler schedules the send time for each access unit in order from the access unit with the greatest decode time to the access unit with the smallest decode time. The system also includes a data storage unit coupled to said object scheduler. The data storage unit is adapted to store the plurality of objects and transfer said plurality of objects to said object scheduler when prompted.

In accordance with another preferred arrangement, a method for scheduling an object-based audiovisual presentation is provided, where the presentation includes a plurality of core objects and a plurality of interactive objects. In this arrangement, each core object includes a plurality of core access units and each interactive object includes a plurality of interactive access units. Preferably, a send time is scheduled for each core access unit over a channel at a first capacity. In addition, a send time for each interactive access unit is scheduled over said channel at a second capacity. In accordange with another preferred arrangement, each interactive access unit is scheduled in a plurality of gaps on the channel.

### BRIEF DESCRIPTION OF THE DRAWINGS

Further objects, features and advantages of the invention will be come apparent from the following detailed description taken in conjunction with the accompanying figures showing illustrative embodiments of the invention in which:

FIG. 1 is a functional block diagram illustrating one embodiment of the present system.

FIG. 2 is a descriptive block diagram illustrating an exemplary object-based presentation and an exemplary scheduled object based presentation.

FIG. 3 is a flow chart illustrating an exemplary methodology that may be carried out in the system of FIG. 1.

FIG. 4 is a flow chart illustrating an exemplary methodology that may be carried out in the system of FIG. 1.

FIG. 5 is a more detailed flow chart of process block 410 of FIG. 4.

FIG. 6 is a flow chart illustrating an exemplary methodology that may be carried out in the system of FIG. 1.

FIG. 7 is a flow chart illustrating an exemplary methodology that may be carried out in the system of FIG. 1.

FIG. 8 is a flow chart illustrating an exemplary methodology that may, be carried out in the system of FIG. 1.

FIG. 9 is a flow chart illustrating an exemplary methodology that may be carried out in the system of FIG. 1.

FIG. 10 is a flow chart illustrating an exemplary methodology that may be carried out in the system of FIG. 1.

FIG. 11 is a flow chart illustrating an exemplary methodology that may be carried out in the system of FIG. 1.

FIG. 12 is a flow chart illustrating an exemplary methodology that may be carried out in the system of FIG. 1.

Throughout the figures, the same reference numeral and character, unless otherwise stated, are used to denote like features, elements, components or portions of the illustrated embodiments.

### DESCRIPTION OF PREFERRED EMBODIMENTS

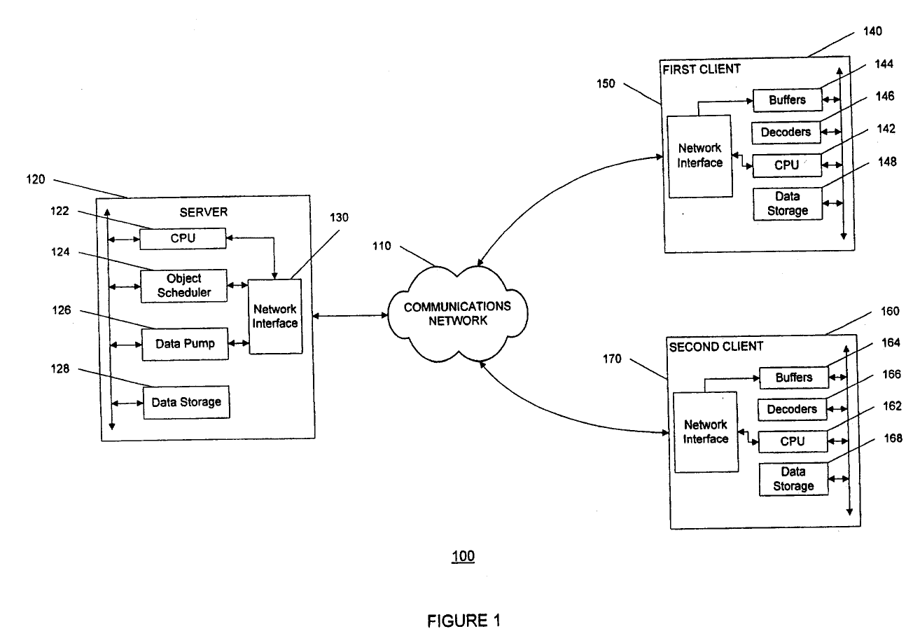

Referring to FIG. 1, a preferred embodiment of the present invention will be described. FIG. 1 depicts a simplified block diagram of a system 100. A server 120 is provided which includes a CPU 122, an object scheduler 124, a data pump 126, a data storage device 128, and a network interface 130. The server computer may be a Dell Desktop PC, or any other computer of suitable processing power. The data scheduler 124 and the data pump 126 are implemented as software modules in the C++ programming language. The server 120 is connected to a network 110, which preferably uses an Internet protocol, and can communicate through the network 110. A first client 140 is provided which includes a CPU 142, buffers 144, decoders 146, data storage 148, and a network interface 150. The client computer may be a Dell Desktop PC, or any other computer of suitable processing power. The first client 140 is connected to the network 110 and can communicate through the network 110. A second client 160 is provided which includes a CPU 162, buffers 164, decoders 166, data storage 168, and a network interface 170. The second client 160 is connected to the network 110 and can communicate through the network 110.

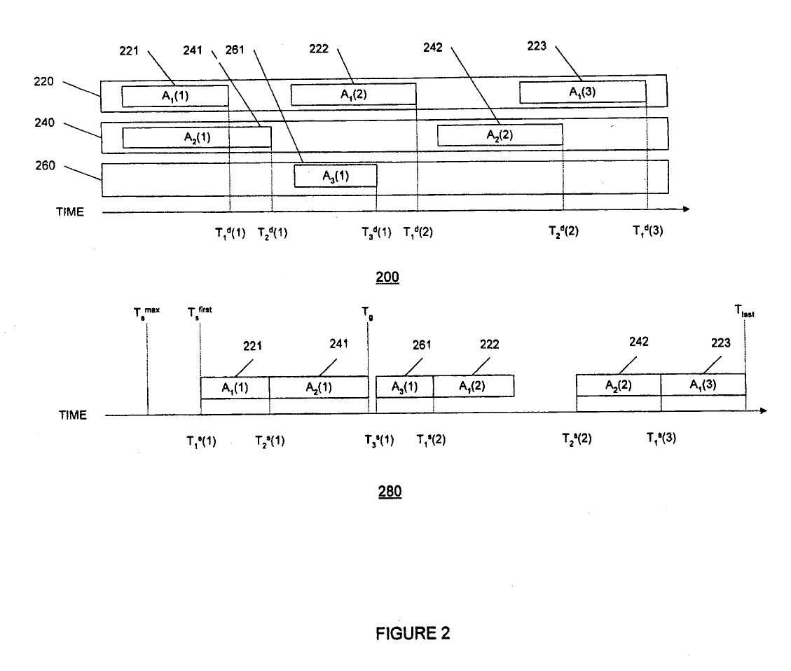

The server 120 is specially adapted to transmit object-based audiovisual presentations to a plurality of clients. An object-based audiovisual presentation is make up of a number of objects. FIG. 2 is a representation of an exemplary object-based audiovisual presentation 200. The presentation 200 has three objects: a first object 220, a second object 240, and a third object 260. Each object has a priority associated with it, and a list of access units. An object may have any number of access units associated with it. The first object 220 has three access units: an access unit 221, an access unit 222, and an access unit 223. The second object 240 has two access units: an access unit 241 and an access unit 242. The third object 260 has one access unit, access unit 261.

Each access unit has two parts: a decode time and data. An access unit is notated by Aⱼ(xⱼ), where j is the object index and xⱼ is the access unit index for the j^{th} object. For example, the first access unit 221 of the first object 220 would be notated as A₁(1) or A₁(x₁) where x₁ is equal to 1. The decode time of the access unit tells the server 120 and the client what time the access unit is to be decoded by a client for the presentation. The decode time is generally expressed in milliseconds. The decode time of an access unit is notated by Tⱼ^{d}(xⱼ), where j is the object index and xⱼ is the access unit index for the j^{th} object. For example, the first access unit 221 of object 220 would have a decode time of T₁^{d}(1) or T₁^{d}(x₁) where x₁ is equal to 1. The data of the access unit is the information that forms the presentation.

The access unit also has a size. The size of an access unit can be determined by the server 120. In an alternate embodiment, the size can be computed and stored with the access unit along with the decode time. The size of the access unit describes the size, in bytes, of the access unit. The size of the access unit is notated by sⱼ(xⱼ), where j is the object index and xⱼ is the access unit index for the j^{th} object. An access unit can be of any size.

The transmission of a presentation begins when the server 120 receives a request to transmit the presentation to a particular client, here the first client 140. The server 120 ascertains the maximum capacity (C^{max}), expressed in bits per second, of the network connection between the server 120 and the first client 140 and the maximum capacity of the buffers 144 (B^{max}) of the first client 140. And the server 120 communicates C^{max} and B^{max} to the object scheduler 124 to schedule transmission of the presentation to the first client 140.

To schedule and transmit the presentation, the data storage unit 128 transfers certain information about each object, object by object, included in the presentation to the data pump 126 and the object scheduler 124. The information about the access units is transferred to the data pump 126 for later transmission over the network 110. The object scheduler 124 receives information about the objects, the decode times for the access units, and the sizes of the access units. The object scheduler 124 schedules the presentation based in part on the decode time of each access unit, the size of each access unit, the priority of the object, the C^{max}, and the B^{max}.

A scheduled presentation 280 is also shown in FIG. 2. For a presentation to be scheduled, the server 120 must deliver each of the required access units to the client before the decode time for each of the access units without violating the maximum startup delay (Tₛ^{max}). Tₛ^{max} is calculated by dividing B^{max} by the capacity used to schedule the presentation. In an alternate embodiment, Tₛ^{max} may be set according to a user's preferences. While scheduling a presentation, the object scheduler 124 sets the send time for each access unit. The send time is notated by Tⱼ^{s}(xⱼ), where j is the object index and xⱼ is the access unit index for the j^{th} object. For example, the first access unit 221 of object 220 would have a send time of T₁^{s}(1) or T₁^{s}(x₁) where x₁ is equal to 1. The send time for each access unit must be set after Tₛ^{max} for the presentation to be schedulable. The data pump 126 transmits each access unit to the network interface 130 which sends the information through the network 110 to the first client 140 when instructed to do so by the object scheduler 124.

The network interface 150 of the first client 140 receives each access unit sent by the server 120 after a transmission delay. The network interface 150 receives the data and stores it into the buffers 144. The buffers 144 hold the data until the decode time for a particular access unit. At that time the buffers 144 transfer the data to the decoders 146 which decode the data for real-time playback.

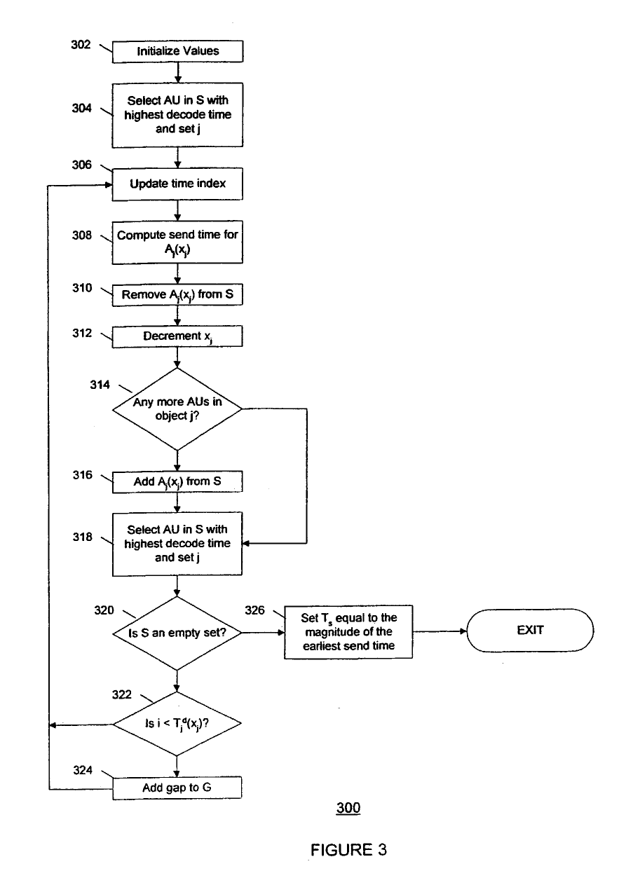

FIG. 3 is a flow chart 300 depicting a first exemplary embodiment of the process by which a presentation is scheduled in accordance with the present invention, which shall be referred to as “Full Schedule.” Full Schedule schedules a presentation to minimize startup delay. The main principle behind this algorithm is to schedule the access unit with the latest decode time first, and schedule it as close to its decode time as possible. The object scheduler 124 computes the schedule, the required startup delay, and any channel idle times. The server 120 begins the scheduling of a presentation by transferring control to the object scheduler 124. The object scheduler then executes process block 302. In FIG. 3 and the following Figures, process blocks represent the logical steps that are implemented by software being executed on a Intel Pentium III processor, or any other processing device capeable of executing the software. The software may be written in C++ or any other programming language capeable of describing the processes.

Process block 302 causes the object scheduler 124 to initialize values. Each index xⱼ is initialized to the total number of access units in the respective object. For example, for the presentation 200, x₁=3, x₂=2, x₃ =1. The set S is initialized to contain the access unit with the greatest decode time of each object. For example, for the presentation 200, S is initialized to contain A₁(3), A₂(2), and A₃(1). The set of idle times (G) is initialized to contain nothing. And finally, the time index (i) is initialized to infinity. After the values are initialized the object scheduler 124 executes process block 304.

Process block 304 causes the object scheduler 124 to select the access unit with the highest decode time from the set S, and sets j equal to the object number of the object to which the selected access unit belongs. For example, for the presentation 200, if A₁(3) is selected, j is set to 1. The object scheduler 124 must also set Tₗₐₛₜ equal to the highest decode time. After Tₗₐₛₜ is set, the object scheduler 124 executes process block 306.

Process block 306 causes the object scheduler 124 to update the time index i. The time index is updated to equal the smaller of the current value of the time index or the decode time of Aⱼ(xⱼ). After the time index is updated the object scheduler executes process block 308.

Process block 308 causes the object scheduler 124 to compute and record the send time for Aⱼ(xⱼ). The send time of the access unit is notated by Tⱼ^{s}(xⱼ), where j is the object index and xⱼ is the access unit index for the j^{th} object. Tⱼ^{s}(xⱼ) is calculated by subtracting the duration of Aⱼ(xⱼ) from the current value of i. The duration of the access unit is notated by dⱼ(xⱼ), where j is the object index and xⱼ is the access unit index for the j^{th} object, and is calculated by dividing sⱼ(xⱼ) by C. The time index (i) is set equal to Tⱼ^{s}(xⱼ). After Tⱼ^{s}(xⱼ) is calculated the object scheduler 124 executes process block 310.

Process block 310 causes the object scheduler 124 to remove Aⱼ(xⱼ) from the set S. Aⱼ(xⱼ) is removed from the set because Tⱼ^{s}(xⱼ) has been set. After Aⱼ(xⱼ) is removed, the object scheduler executes process block 312.

Process block 312 causes the object scheduler 124 to decrement xⱼ. This causes Aⱼ(xⱼ) to point to the next access unit within the j^{th} object. Since the access units are transferred to the object scheduler in order, the access units within each object are sorted according to decode time. Decrementing xⱼ results in Aⱼ(xⱼ) pointing to the access unit of object j with the next highest decode time. After the object scheduler 124 decrements xⱼ, the object scheduler 124 executes decision block 314.

The object scheduler 124 determines if there are any more access units in the object j to schedule while executing decision block 314. If xⱼ is greater than 0 there are additional access units of object j to schedule and the object scheduler 124 executes process block 316. If xⱼ is less than or equal to 0 there are no additional access units of object j to schedule, and the object scheduler 124 executes process block 318.

Process block 316 causes the object scheduler 124 to add Aⱼ(xⱼ) to the set S. Aⱼ(xⱼ) points to an unscheduled access unit in object j with the latest decode time among the unscheduled access units because xⱼ was decremented in process block 312. After Aⱼ(xⱼ) is added to the set S, the object scheduler 124 executes process block 318.

Process block 318 causes the object scheduler 124 to select the access unit with the highest decode time from the set S, and set j equal to the object number of the object to which the selected access unit belongs. After j is set, the object scheduler 124 executes decision block 320.

While executing decision block 320, the object scheduler 124 reads the set S to ascertain whether the set S is an empty set. If the set S is an empty set, the object scheduler 124 executes process block 326. If there are access units in the set S, the object scheduler 124 executes decision block 322.

While executing decision block 322, the object scheduler 124 must see if a gap exists on the channel. A gap will exist on the channel if the time index, which is equal to the send time of the last scheduled access unit, is greater than the Tⱼ^{d}(xⱼ). If a gap exists it must be added to the set G, therefore the object scheduler 124 must execute process block 324. If no gap exists, then the object scheduler 124 executes process block 306.

Process block 324 causes the object scheduler 124 to add the gap on the channel to the set G. The gap is added to the set G as a tuple <t, d> where t stands for the start time of the gap, and d stands for the duration of the gap. The start time describes the later edge of the gap on the channel, for example, if a gap begins at time 4 and ends at time 7 the tuple would be <7, 3>. The start time (t) is equal to the time index (i), and the duration is the difference between the time index (i) and Tⱼ^{d}(xⱼ). The object scheduler 124 adds the tuple to the set G then executes the process block 306.

Process block 326 causes the object scheduler 124 to set the startup delay (Tₛ) equal to the magnitude of the time index (i). After the object scheduler 124 sets the startup delay, the objects scheduler 124 exits process block 404.

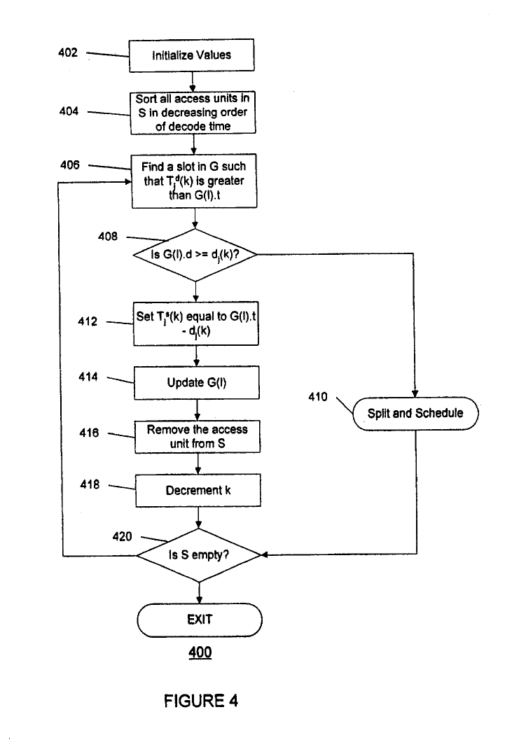

FIG. 4 is a flow chart 400 depicting a second exemplary embodiment of the process by which a presentation is scheduled in accordance with the present invention, which shall be referred to as “Gap Schedule.” Gap Schedule schedules access units in the available gaps on a channel. The server 120 begins the scheduling of a presentation by transferring control to the object scheduler 124. The object scheduler then executes process block 402.

Process block 402 causes the object scheduler 124 to initialize values. The set S is initialized to contain all the access units for every object to be scheduled. The index k is set equal to the number of access units in the set S. After the values are initialized the object scheduler 124 executes process block 404.

Process block 404 causes the object scheduler 124 to sort the access units in S in increasing order of decode time. This is done so that the first access unit in set S has the lowest decode time, i.e. will be decoded first by the client, and the last access unit in set S has the highest decode time. The object scheduler 124 then executes process block 406.

Process block 406 causes the object scheduler 124 to find a suitable gap for Aⱼ(k) or the k^{th} access unit of the set S. The object scheduler 124 searches through the set G, starting with the last gap in the list, to find a gap such that Tⱼ^{d}(k) is greater than the start time for the gap. The set G lists gaps in increasing order of start times. Once a suitable gap is found, the index 1 is set to the selected gap number. After 1 is set, the object scheduler 124 executes decision block 408.

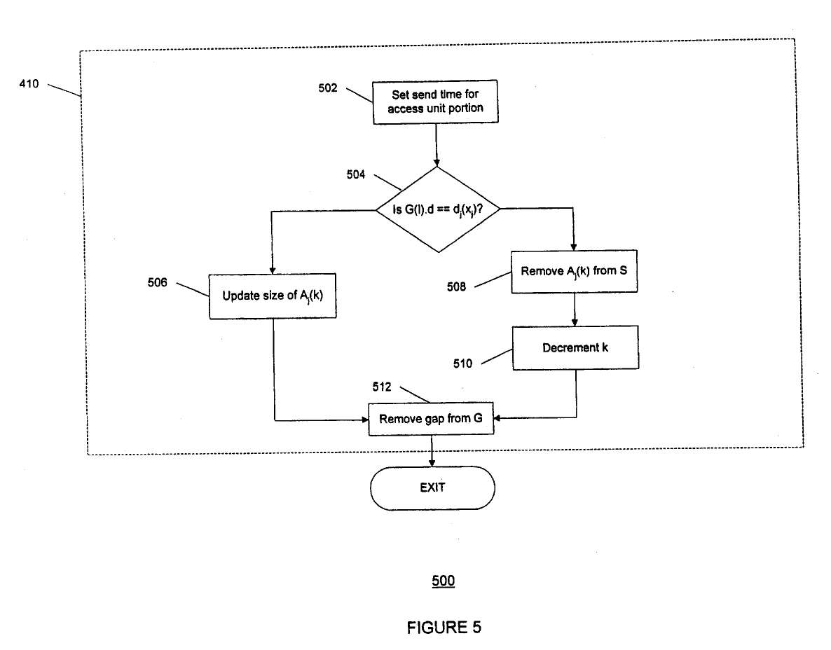

While executing decision block 408 the object scheduler 124 must determine if the access unit can fit within the confines of G(1) or the 1^{th} gap in the set G. This is accomplished by comparing G(1).d, the duration of gap 1, to dⱼ(k), the duration of Aⱼ(k). If the gap is longer than A; (k) the process block 412 is executed. Otherwise, process block 410 is executed. The process block 410 is shown in more detail in FIG. 5. After the object scheduler 124 exits process block 410, the object scheduler 124 executes decision block 420.

Process block 412 causes the object scheduler 124 to set the send time (Tⱼ^{s}(k) for Aⱼ(k). The Tⱼ^{s}(k) is set equal to G(1).t minus dⱼ(k). After the send time is set, the object scheduler 124 executes process block 414.

Process block 414 causes the object scheduler 124 to update the information describing the gap G(1). An access unit which will be sent during the gap G(1) will always be sent in the later portion of the gap. The information describing the gap must be updated to reflect this change. G(1).t is set equal to G(1).t−dⱼ(k), and G(1).d is set equal to G(1).d−dⱼ(k). After the gap information is updated, the object scheduler executes process block 416.

Process block 416 causes the object scheduler 124 to remove the access unit Aⱼ(k) from the set S. The access unit Aⱼ(k) has been scheduled so there is no reason to keep the access unit is the set S any longer. Once the access unit Aⱼ(k) is removed from S, the object scheduler 124 executes process block 418.

Process block 418 causes the object scheduler 124 to decrement the index k. Decrementing the index k causes the index k to point to the next access unit to be scheduled. The object scheduler 124 then- executes decision block 420.

While executing decision block 420, the object scheduler 124 reads the set S to determine whether the set S is an empty set. If S is an empty set, the object scheduler 124 exits the Gap Schedule Process. If S is not an empty set, the object scheduler 124 executes process block 406.

FIG. 5 shows process block 410 in more detail. Process block 410 is used to schedule the transmission of an access unit in a gap of equal or lesser duration than that of the access unit being scheduled. The object scheduler 124 begins execution of process block 410 by executing process block 502. Process block 502 sets the send time for the access unit portion that fits within the gap. After the send time is set, the object scheduler 124 executes decision block 504.

While executing decision block 504, the object scheduler 124 must determine whether the duration of the gap is exactly the same as the duration of the access unit. The object scheduler 124 compares G(1).d and dⱼ(k), if equal the process block 508 is executed. Otherwise, the process block 506 is executed.

Executing process block 506 causes the object scheduler 124 to update the size of the access unit Aⱼ(k). The size of the access unit, sⱼ(k), is decreased by G(1).d*C. After sⱼ(k) is set, the process block 512 is executed.

Executing process block 508 causes the object scheduler 124 to remove the access unit Aⱼ(k) from the set S. If the gap duration is the same as the access unit duration the whole access unit is sent in the gap G(1). The object scheduler 124 then executes process block 510, which decrements index k, and executes process block 512

Executing process block 512 causes the object scheduler 124 to remove the gap G(1) from the set G. Once the gap is removed from the set G, process block 512 is exited which in turn exits process block 410.

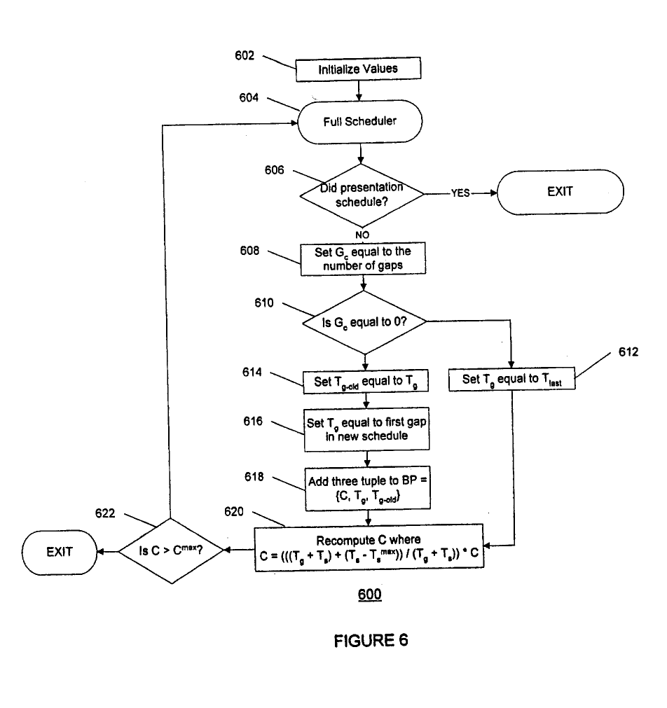

FIG. 6 is a flow chart 600 depicting a third exemplary embodiment of the process by which a presentation is scheduled in accordance with the present invention, which shall be referred to as “MinC Schedule.” The MinC Schedule schedules the presentation while using the minimum capacity possible. The scheduler is based on the premise that there is a gap on the channel only when everything else after the gap-time has been scheduled. Therefore, a presentation is not schedulable because there is not enough channel capacity until the first gap time (T_{g}). The server 120 begins the scheduling of a presentation by transferring control to the object scheduler 124. The object scheduler then executes process block 602.

Executing process block 602 causes the object scheduler 124 to initialize values. The bandwidth profile is set equal to the null set (BP={φ}). The minimum capacity (C^{min}) is calculated by dividing the amount of data transferred during the presentation (V_{d}) by the duration of the presentation (Dₚ). The channel capacity (C) is set equal to C^{min}. Tₛ^{max} is calculated by dividing C into B^{max}. The first gap time (T_{g}) is set equal to the latest decode time for any access unit scheduled. After the values are initialized the object scheduler 124 executes process block 604.

Process block 604 causes the object scheduler 124 to execute the process block 302 which initiates the process Full Schedule. The process Full Schedule attempts to schedule the presentation at the current capacity (C). The process Full Schedule outputs either a completed schedule or a failure notice upon completion. After the process Full Schedule completes it exits and the object scheduler 124 executes the decision block 606.

Executing the decision block 606 causes the object scheduler 124 to read the output from the process Full Schedule. If the output from Full Schedule indicated that the presentation did not schedule successfully, the object scheduler 124 executes process block 608. If output from Full Schedule indicates that the presentation did schedule successfully, the object scheduler 124 exits the process MinC Schedule.

Process block 608 causes the object scheduler 124 to set G_{c} equal to the number of gaps recorded by the process Full Schedule. After the object scheduler sets G_{c} the object scheduler 124 executes decision block 610.

Executing the decision block 610 causes the object scheduler 124 to determine whether any gaps exist on the schedule. If a gap exists, i.e. G_{c} is greater than 0, the object scheduler 124 executes process block 614. If no gaps exist, the object scheduler 124 executes process block 612. Process block 612 executes and the object scheduler 124 sets T_{g} equal to Tₗₐₛₜ. Tₗₐₛₜ is the latest decode time for any of the access units scheduled. After T_{g} is set the object scheduler 124 executes process block 620.

Process block 614 causes the object scheduler 124 to set a temporary variable (T_{g-old}) equal to the first gap time (T_{g}). After T_{g-old} is set the object scheduler 124 executes process block 616.

Process block 616 causes the object scheduler 124 to set T_{g} equal to the first gap in the schedule. T_{g} is set equal to the lower bound of the gap (shown in FIG. 2). For example, if the first gap in the channel spans from time 4 to time 7, T_{g} is set equal to 4. After T_{g} is set, the object scheduler 124 executes process block 618.

Process block 618 causes the object schedule 124 to add an element to the bandwidth profile (BP) which describes the period of schedulable presentation. This element is added to the set BP is a three tuple <C, T_{g}, T_{g-old}> where C stands for capacity, T_{g} stands for lower limit of the first gap time, and T_{g-old} stands for the lower limit of the first gap time in the last scheduling iteration. After the three tuple is added to the set BP, the object scheduler 124 executes process block 620.

Process block 620 causes the object scheduler 124 to modify the capacity used to schedule the presentation. The capacity is recomputed according to the following equation: C=[((T_{g}+Tₛ)+(Tₛ−Tₛ^{max}))/(T_{g}+Tₛ)]*C. The values used in this equation are the magnitudes of each value. After C is recomputed, the object scheduler 124 executes decision block 622.

Executing the decision block 622 causes the object scheduler 124 to determine whether the new C is greater than the C^{max}. If the newly computed C is greater than the maximum available capacity, the object scheduler 124 exits the MinC Scheduler. If the newly computed C is not greater than the maximum available capacity, the object scheduler 124 re-executes process block 604. In an alternate embodiment, once C becomes greater than Cₘₐₓ the process block 604 is executed one more time to attempt to schedule the presentation at Cₘₐₓ. If the schedule fails to schedule at Cₘₐₓ the MinC scheduler exits.

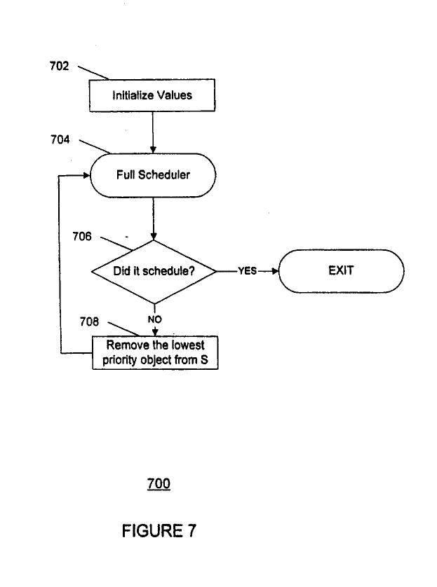

FIG. 7 is a flow chart 700 depicting a fourth exemplary embodiment of the process by which a presentation is scheduled in accordance with the present invention, which shall be referred to as “Best Schedule.” The Best Schedule schedules as many of the objects in the presentation as is possible using a priority for the object to select which objects to schedule and which objects not to schedule. The server 120 begins the scheduling of a presentation by transferring control to the object scheduler 124. The object scheduler then executes process block 702.

Executing process block 702 causes the object scheduler 124 to initialize values. The channel capacity (C) is set equal to C^{max}l. Tₛ^{max} is calculated by dividing C into B^{max} The first gap time (T_{g}) is set equal to the decode time of the last access unit scheduled (Tₗₐₛₜ). After the values are initialized the object scheduler 124 executes process block 704.

Process block 704 causes the object scheduler 124 to execute the process block 302 which initiates the process Full Schedule. The process Full Schedule attempts to schedule the presentation at the current capacity (C). The process Full Schedule outputs either a completed schedule or a failure notice upon completion. After the process Full Schedule completes, the object scheduler 124 executes the decision block 706.

Executing the decision block 706 causes the object scheduler 124 to read the output from the process Full Schedule. If the output from Full Schedule indicates that the presentation did not schedule successfully, the object scheduler 124 executes process block 708. If output from Full Schedule indicates that the presentation did schedule successfully, the object scheduler 124 exits the process Best Schedule.

Process block 708 causes the object scheduler 124 to remove the object with the lowest priority from the set of objects to be scheduled. If more than one object has the same priority the smallest object that has a size greater than (Tₛ^{max}−Tₛ)*C is selected to be removed or if no object is larger than (Tₛ^{max}−Tₛ)*C the largest object is selected. After the object is removed, process block 704 is executed by the object scheduler 124. In an alternate embodiment objects are removed according to priority until the objects removed have a cumulative file number less than (Tₛ^{max}−T_{g})*C.

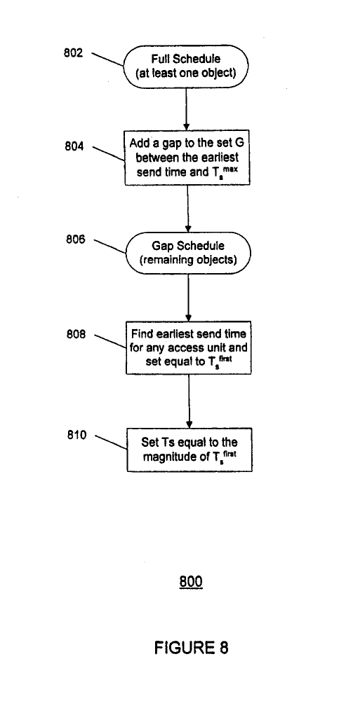

FIG. 8 is a flow chart 800 depicting a fifth exemplary embodiment of the process by which a presentation is scheduled in accordance with the present invention, which shall be referred to as “Incremental Schedule.” The Incremental Schedule schedules objects one at a time. The scheduler is based on the premise that if an objects is added to a presentation the whole presentation does not have to be rescheduled, only the new object has to be scheduled. The server 120 begins the scheduling of a presentation by transferring control to the object scheduler 124. The object scheduler then executes process block 802.

Executing process block 802 causes the object scheduler 124 to schedule at least one object of the presentation using the Full Schedule Process. After the Full Schedule Process exits, the object scheduler 124 executes process block 804.

The object scheduler 124 adds a gap to the set of gaps G while executing process block 804. The gap between the first send time for an access unit as scheduled by the Full Schedule Process and Tₛ^{max} is added to the set G. Once the gap is added, the object scheduler 124 executes process block 806.

Executing process block 806 causes the object scheduler 124 to schedule at least one object of the presentation using the Gap Schedule Process. After the Gap Schedule Process exits, the object scheduler 124 executes process block 808.

Executing process block 808 causes the object scheduler 124 to set Tₛ. Tₛ is set equal to the magnitude of the first send time for any of the scheduled access units. After Ts is set, the Incremental Schedule exits. In an alternative embodiment gap schedule can be called every time a new access unit is added.

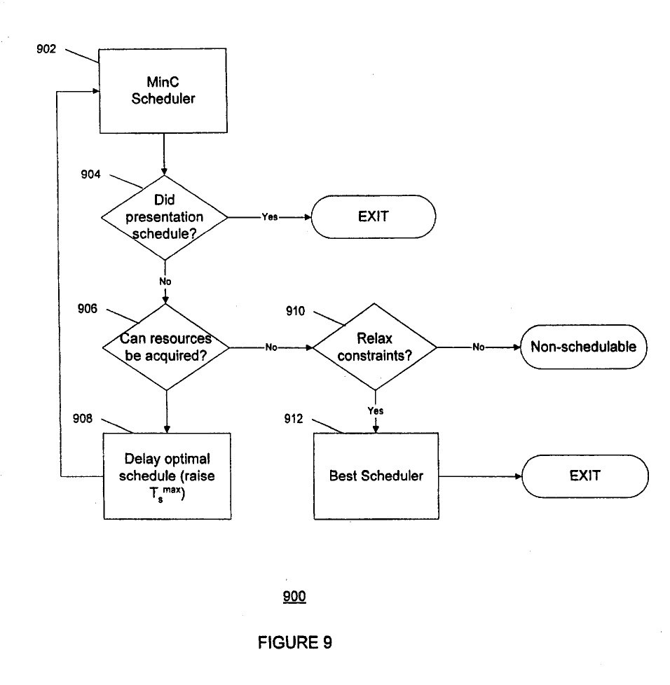

FIG. 9 is a flow chart 900 depicting a sixth exemplary embodiment of the process by which a presentation is scheduled in accordance with the present invention, which shall be referred to as “Main Schedule.” The server 120 begins the scheduling of a presentation by transferring control to the object scheduler 124. The object scheduler then executes process block 902.

Process block 902 causes the object scheduler 124 to call the MinC Scheduler. The MinC Scheduler is provided with the access units that must be scheduled, the maximum capacity, and the maximum setup delay. After the MinC Scheduler exits the object scheduler 124 executes decision block 904.

Executing the decision block 904 causes the object scheduler 124 to read the output from the process MinC Schedule. If the output from MinC Schedule indicates that the presentation did not schedule successfully, the object scheduler 124 executes decision block 906. If output from MinC Schedule indicates that the presentation did schedule successfully, the object scheduler 124 exits the process Main Schedule.

Executing the decision block 906 causes the object scheduler 124 to determine if resources can be acquired. If resources can be acquired, the object scheduler 124 executes process block 908. Otherwise, the object scheduler 124 executes decision block 910.

Process block 908 causes, the object scheduler 124 to raise the value of Tₛ^{max}. Because the MinC Schedule was used but failed to schedule the presentation, a schedule using the maximum capacity for the channel has already been attempted. The only resource that can be acquired is setup time. After the setup time is increased, the object scheduler 124 executes process block 902.

If no resources can be acquired, decision block 910 is executed which causes the object scheduler 124 to determine if any constraints can be relaxed. If constraints can be relaxed, the object scheduler 124 executes process block 912, which executes the Best Schedule process. After the Best Schedule process exits, the Main Schedule process is complete and it exits. If constraints cannot be relaxed, the presentation is not schedulable.

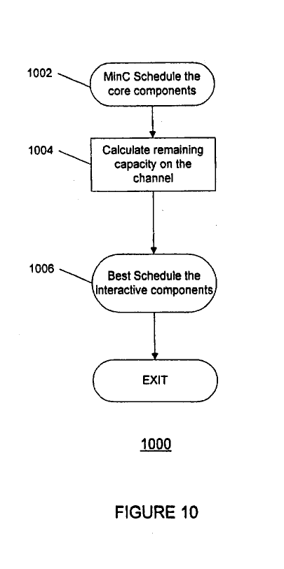

FIG. 10 is a flow chart 1000 depicting a seventh exemplary embodiment of the process by which a presentation is scheduled in accordance with the present invention, which shall be referred to as “Reserved Interactive Schedule.” The Reserved Interactive Scheduler operates on the premise that the presentation has been divided into an interactive portion and a core portion. The interactive portion of the presentation is transmitted to a client using the bandwidth of the channel that the core portion of the presentation did not need to use. The server 120 begins the scheduling of a presentation by transferring control to the object scheduler 124. The object scheduler then executes process block 1002.

Process block 1002 causes the object scheduler 124 to call the MinC Scheduler. The MinC Scheduler is provided with the access units making up the core portion of the presentation, the maximum capacity, and the maximum setup delay. After the MinC Scheduler exits the object scheduler 124 executes process block 1004.

Process block 1004 causes the object scheduler 124 to calculate the remaining capacity on the channel. The object scheduler 124 sets C_{new} equal to Cₘₐₓ minus C, where C is the capacity used by the MinC Scheduler in process block 1002. After C_{new} is set, the object scheduler 124 executes process block 1006.

Process block 1006 causes the object scheduler 124 to call the Best Scheduler. The Best Scheduler is provided with the access units making up the interactive portion of the presentation, the C_{new}, and the maximum setup delay. The Best Scheduler schedules as much of the interactive portion of the presentation at capacity C_{new} as possible. After the Best Scheduler exits, the Reserved Interactive Process exits.

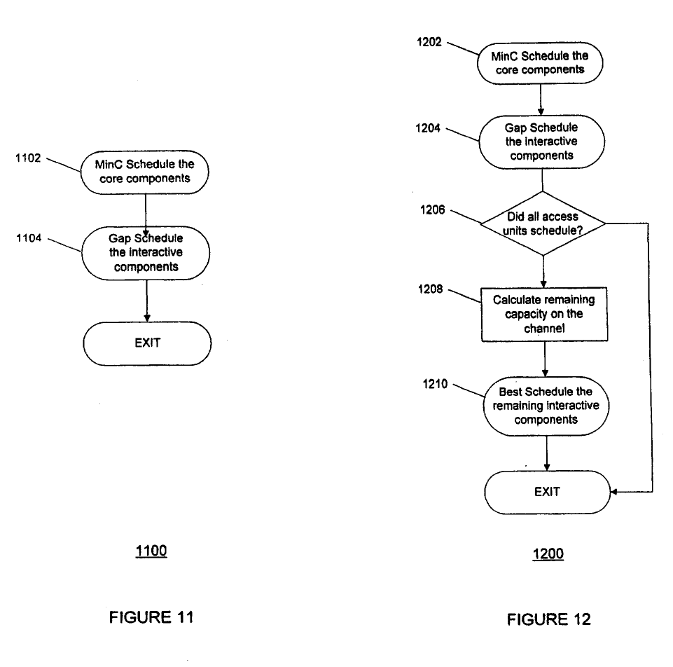

FIG. 11 is a flow chart 1100 depicting an eighth exemplary embodiment of the process by which a presentation is scheduled in accordance with the present invention, and will be referred to as “Second Tier Interactive Schedule.” The Second Tier Interactive Scheduler operates on the premise that the presentation has been divided into an interactive portion and a core portion. The interactive portion of the presentation is transmitted to a client using the gaps in the channel that the core portion of the presentation did not use. The server 120 begins the scheduling of a presentation by transferring control to the object scheduler 124. The object scheduler then executes process block 1102.

Process block 1102 causes the object scheduler 124 to call the MinC Scheduler. The MinC Scheduler is provided with the access units making up the core portion of the presentation, the maximum capacity, and the maximum setup delay. After the MinC Scheduler exits the object scheduler 124 executes process block 1104.

Process block 1104 causes the object scheduler 124 to call the Gap Scheduler. The Gap Scheduler is provided with the access units making up the interactive portion of the presentation and the set of gaps generated by the MinC Scheduler. After the Gap Scheduler exits, the Second Tier Interactive Process exits.

FIG. 12 is a flow chart 1200 depicting an exemplary embodiment of the process by which a presentation is scheduled in accordance with the present invention, the process is called Hybrid Interactive Schedule. The Hybrid Interactive Scheduler operates on the premise that the presentation has been divided into an interactive portion and a core portion. The interactive portion of the presentation is transmitted to a client using the gaps in the channel that the core portion of the presentation did not use and the bandwidth of the channel that the core portion of the presentation did not need to use. The server 120 begins the scheduling of a presentation by transferring control to the object scheduler 124. The object scheduler then executes process block 1202.

Process block 1202 causes the object scheduler 124 to call the MinC Scheduler. The MinC Scheduler is provided with the access units making up the core portion of the presentation, the maximum capacity, and the maximum setup delay. After the MinC Scheduler exits the object scheduler 124 executes process block 1204.

Process block 1204 causes the object scheduler 124 to call the Gap Scheduler. The Gap Scheduler is provided with the access units making up the interactive portion of the presentation and the set of gaps generated by the MinC Scheduler. After the Gap Scheduler exits, the decision block 1206 is executed.

Executing the decision block 1206 causes the object scheduler 124 to look at the output from the Gap Scheduler. If the Gap Scheduler scheduled all of the interactive portion of the presentation, the Hybrid Interactive Scheduler exits. If the Gap Scheduler did not schedule all of the interactive portion of the presentation, the object scheduler 124 executes process block 1208.

Process block 1208 causes the object scheduler 124 to calculate the remaining capacity on the channel. The object scheduler 124 sets C_{new} equal to Cₘₐₓ minus C, where C is the capacity used by the MinC Scheduler in process block 1202. After C_{new} is set, the object scheduler 124 executes process block 1210.

Process block 1210 causes the object scheduler 124 to call the Best Scheduler. The Best Scheduler is provided with the access units making up the interactive portion of the presentation, the C_{new}, and the maximum setup delay. The Best Scheduler schedules as much of the interactive portion of the presentation as possible. After the Best Scheduler exits, the Hybrid Interactive Process exits.

The above-described processes are exemplary. Indeed, different scheduling processes may be utilized that are within the scope of the present invention. For example: any of the disclosed scheduling processes can be used during an author's presentation creation process. As an author adds new objects to the presentation, a scheduler can be invoked to schedule the presentation, the incremental scheduler is particularly adapted for this purpose. This will allow the author to tell if the presentation is schedulable while creating different objects and allow the author to move objects around to make the presentation both more informative and schedulable. It should be appreciated that those skilled in the art will be able to devise numerous embodiments which, although not explicitly shown or described herein, embody the principles of the invention and are thus within the spirit and scope of the present invention.

1. A method for scheduling a plurality of objects for an object-based audiovisual presentation, wherein each object includes a plurality of access units, and wherein each access unit includes a decode time and data, comprising:
scheduling a send time for each access unit over a channel at a capacity; and,
scheduling the send time for each access unit in order from the access unit with the greatest decode time to the access unit with the smallest decode time.

2. The method according to claim 1, wherein each access unit is scheduled as closely as possible to the decode time of each access unit.

3. The method according to claim 1, wherein a plurality of gaps on the channel are recorded during scheduling.

4. The method according to claim 3, wherein each gap of said plurality of gaps is recorded as a tuple.

5. The method according to claim 4, wherein said tuple comprises a start time for said gap and a duration for said gap.

6. The method according to claim 3, comprising the further step of scheduling a second plurality of access units, comprising:
scheduling a send time for each access unit over said channel at said capacity;
scheduling the send time for each access unit in order from the access unit with the greatest decode time to the access unit with the smallest decode time; and
scheduling the send time for each access unit such that each access unit is sent in one of the plurality of gaps.

7. The method according to claim 6, wherein said one of the plurality of gaps has a longer duration than said access unit.

8. The method according to claim 7, wherein said one of the plurality of gaps has the same duration as said access unit.

9. The method according to claim 6, wherein said access unit is divided into a first portion equal in duration to one of said plurality of gaps and a second portion.

10. The method according to claim 9, wherein said first portion of said access unit is scheduled in said one of said plurality of gaps.

11. The method according to claim 10, wherein said second portion of said access unit is scheduled in at least one of the plurality of gaps.

12. The method according to claim 6, wherein each access unit is scheduled in the first gap preceding the decode time of said each access unit.

13. The method according to claim 1, wherein a first object of said plurality of objects additionally comprises a first priority.

14. The method according to claim 13, wherein a second object of said plurality of objects additionally comprises a second priority.

15. The method according to claim 14, wherein said second object is not scheduled because both said first object and said second object cannot be scheduled and said first priority is higher than said second priority.

16. The method according to claim 1, wherein said capacity is set at a first capacity.

17. The method according to claim 16, wherein said first capacity is calculated by dividing the size of the presentation by the duration of the presentation.

18. The method according to claim 16, comprising the further step of scheduling the plurality of objects at an increased second capacity because no schedule could be found at said first capacity.

19. The method according to claim 1, wherein said plurality of objects must be scheduled before a maximum setup time.

20. A system for scheduling an object-based audiovisual presentation including a plurality of objects, wherein each object includes a plurality of access units, and wherein each access unit includes a decode time and data, comprising:
an object scheduler for scheduling a send time for each access unit over a channel at a capacity;
said object scheduler scheduling the send time for each access unit in order from the access unit with the greatest decode time to the access unit with the smallest decode time; and
a data storage unit coupled to said object scheduler, adapted to store the plurality of objects and transfer said plurality of objects to said object scheduler when prompted.

21. A method for scheduling an object-based audiovisual presentation, comprising:
a plurality of core objects wherein each object includes a plurality of core access units;
a plurality of interactive objects wherein each object includes a plurality of interactive access units;
scheduling a send time for each core access unit over a channel at a first capacity;
scheduling the send time for each core access unit in order from the access unit with the greatest decode time to the access unit with the smallest decode time.

22. The method of claim 21, comprising the further step of scheduling a send time for each interactive access unit over said channel at a second capacity.

23. The method of claim 21, wherein a plurality of gaps in the channel are recorded.

24. The method of claim 23, comprising the further step of scheduling each interactive access unit in the gaps on the channel.

25. A method for editing an object-based audiovisual presentation, including a plurality of objects, wherein each object includes a plurality of access units, and wherein each access unit includes a decode time and data, comprising:
editing an object of said object-based audiovisual presentation; and
scheduling said object-based audiovisual presentation.
